(19) United States
(12) Patent Application Publication
(10) Pub. No.: US 2010/0122871 A1
(43) Pub. Date: May 20, 2010

(54) Tractor Tire-Mountable Folding Step Ladder

(75) Inventor: George Gottlinger, Tucson, AZ (US)

Correspondence Address: THE LUTHER LAW FIRM, PLC, 10575 N 114TH STREET, SUITE 103, SCOTTSDALE, AZ, 85259, US

(73) Assignee: UPSHOT INNOVATIONS PRODUCT DEVELOPMENT, LLC, Tucson, AZ (US)

(21) Appl. No.: 12/404,639

(22) Filed: Mar. 16, 2009

Related U.S. Application Data
(60) Provisional application No. 61/115,900, filed on Nov. 18, 2008.

(51) Int. Cl. B60R 3/00; E06C 7/18; E06C 5/24; E06C 5/02

(52) U.S. Cl. 182/106

(57) ABSTRACT

A portable, foldable step ladder in a deployed configuration straddles a tire of a truck, tractor or other heavy vehicle, allowing an operator and mechanic to easily climb toward the engine compartment. A top step rests on the uppermost portion of the tire tread. A middle step and a bottom step are suspended from the top step and, together with their suspensory structure, are foldable into proximity with the bottom surface of the top step. On each side of the top step, a hand rail has a lower portion rotatably connected to the side of the top step near the front thereof. Each hand rail has a transverse portion extending toward the rear of the top step and, attached to the transverse portion, a rear portion extending downward and connected to the sides of the top step near the rear thereof. The hand rail assembly engages the side walls of the tire in hook-like fashion, stabilizing the top step, while the top step supports the hand rail assembly at four points. The hand rail rear portion is removable from the top step, whereupon the top step swings down between the hand rail front portions. The hand rail transverse portions are then rotatable relative to the lower portions, swinging the rear portions into front and rear abutment with the compactly folded step assembly, securing the step assembly.

### CROSS REFERENCES TO RELATED APPLICATIONS

This application claims the benefit of Provisional Application No. 61/115,900 filed Nov. 18, 2008.

### BACKGROUND OF THE INVENTION

1. Field of the Invention

The present invention relates to a step ladder for servicing large motor vehicles, more particularly where the step ladder is hand portable, and especially where it is foldable.

2. General Background and State of the Art

Tractor trailer operators need to access the engine compartment in all types of weather. Operator steps detachably engaged with a truck's front wheel and tire include U.S. Pat. Nos. 2,851,312; 3,590,950; 4,800,987; 4,947,961; 5,133,429; 7,168,523; 6,767,023; 6,550,578; 6,044,928; and 4,782,916. All have one or more steps for climbing. All appear to have structure engaging the inner side wall, tread, and outer sidewall of a truck tire. Most appear to be supported entirely by the truck tire or wheel. Some appear to engage the ground for additional support.

For the most part, the above-identified apparatus appear to lack easily graspable handholds to assist climbing. All but one (U.S. Pat. No. 6,550,578) appear to lack a platform or step positionable at about the level of the tire tread. None of them appear to have a top step or platform positionable directly above the tread. Only some of them appear to fold compactly.

### INVENTION SUMMARY

It is among the objects of the present invention to provide a durable, portable, easily manipulated truck tire mountable step ladder which is also foldable and which improves an operator's ability to climb and carry tools to the engine compartment of a truck tractor or similar vehicle, where the operator needs to safely perform inspections and routine maintenance on a daily basis.

In accordance with these objects and with others which will be described and which will become apparent, an exemplary embodiment of the tire mountable folding step ladder, for temporary attachment to a tire of a front wheel proximate an engine compartment of a tractor, truck cab, or the like, in accordance with the present invention comprises a tire-mountable step assembly and a tire-mountable hand rail assembly linked to the step assembly. The step assembly and the hand rail assembly cooperate to provide a stable step ladder for climbing over the tire toward the engine compartment of the tractor.

In an exemplary embodiment, the hand rail assembly has a hand rail traversing the tread portion of the tire when the step ladder is mounted on the tire, providing a hand-hold for a person standing on the step assembly and reaching into the engine compartment of the tractor.

In an exemplary embodiment, the hand rail is supported at a clearance of at least about 7.5 cm (3 inches) above the top step, assuring that even a thickly gloved hand is able to grasp the hand rail.

In an exemplary embodiment, the hand rail is supported at the clearance by the hand rail assembly and the hand rail assembly is supported by the step assembly.

In an exemplary embodiment, the step assembly rests on the tread portion of the tire and the hand rail assembly is substantially fixed relative to the step assembly.

In an exemplary embodiment, the hand rail assembly stabilizes the step assembly on the tire.

In an exemplary embodiment has a plurality of steps, at least one of the steps being suspended from another of the steps.

In an exemplary embodiment, when the step ladder is removed from the tire, the plurality of steps are manipulable into a configuration wherein all of the plurality of steps are parked together in successive top-to-bottom abutting relation.

In an exemplary embodiment, the step assembly has a top step having side portions, a front, a rear and a tread-engaging bottom surface; and the hand rail assembly has lower portions connected to the side portions of the top step proximate the front portion thereof and extending downward therefrom, a transverse portion extending rearward proximate the side portions of the top step, and a rear portion connected to the side portions of the top step proximate the rear portion thereof and extending downward therefrom. The top step engages the tire tread. The rail assembly engages the inner and outer sidewalls of the tire in hook-like fashion, preventing the top step from sliding off of the tire.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

FIG. 1 is a perspective view of the tractor tire mountable folding step ladder in accordance with the present invention, shown in a mounted relationship with a tractor tire;

FIG. 2 is a perspective view of the tractor tire mountable folding step ladder in accordance with the present invention;

FIG. 3 is a partial perspective view of a bottom step and bottom step supports in accordance with the present invention;

FIG. 4 is a partial perspective view of a middle step and middle step supports in accordance with the present invention;

FIG. 5 is a partial perspective view of a top step in accordance with the present invention;

FIG. 6 is an exploded partial perspective of a hand rail assembly in accordance with the present invention;

FIG. 7 is a partial perspective view of a corner of a top step in accordance with the present invention as seen from beneath;

FIG. 8 is a perspective view of the step ladder in accordance with the present invention in a folded configuration as seen from the front;

FIG. 9 is a perspective view of the step ladder in accordance with the present invention in a folded configuration as seen from the rear;

FIG. 10 is a side elevational view of the step ladder in accordance with the present invention as seen in a folded configuration; and

FIG. 11 is a top plan view of the step ladder in accordance with the present invention as seen in a folded configuration.

FIG. 12 is a bottom sectional view of the bottom step.

### DETAILED DESCRIPTION OF THE PREFERRED EMBODIMENTS

The inventors have discovered that for servicing large motor vehicles it is particularly effective to use a durable, portable, easily manipulated truck tire mountable step ladder which is also foldable and which improves a mechanic's ability to climb and carry tools to the engine compartment of a truck tractor or similar vehicle.

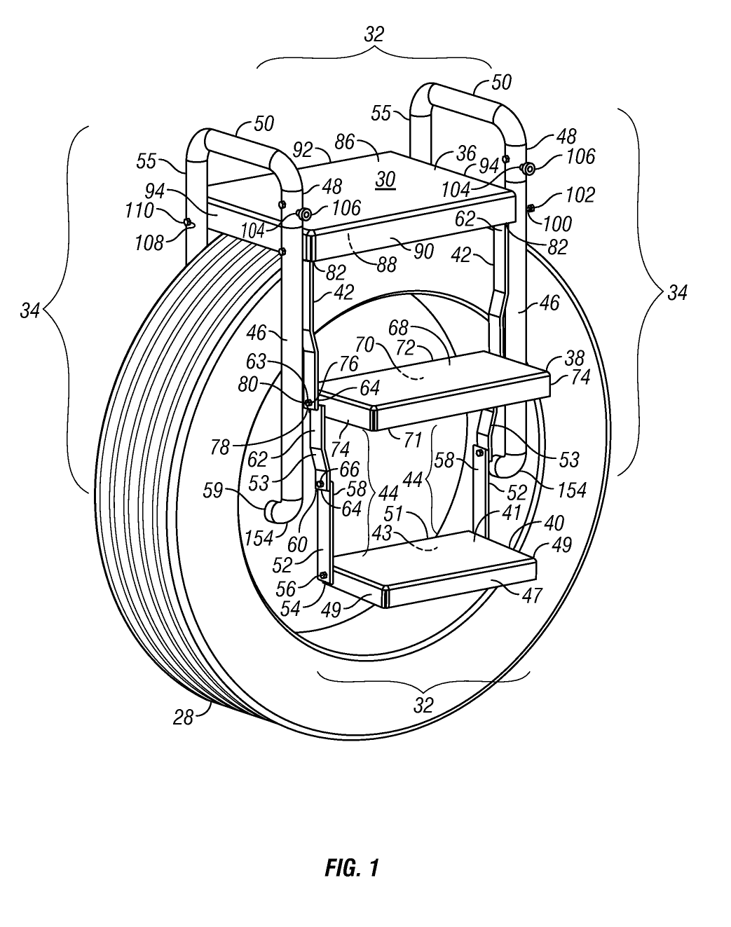

The present invention will now be described with reference to FIG. 1, which illustrates in perspective view a tractor tire 28 supporting a preferred embodiment of the tractor tire mountable folding step ladder 30 in accordance with the present invention, shown generally at 30, having a foldable step assembly 32 located between two tubular handrail assemblies 34. The step assembly 32 rests on the tread portion of the tractor tire 28, engages the tractor tire 28, and enables a person to climb onto and over the tire 28 and, if desired, into the engine compartment of the tractor. The handrail assemblies 34 engage the sidewalls of the tire 28 and the tractor's wheel rim, stabilize the step assembly 32 on the tire 28, provide a hand hold which is safely grasped by the person climbing, and provide for convenient manipulation of the step ladder 30 when deploying or securing the step ladder 30.

The STEP ASSEMBLY 32 has a top step 36, a middle step 38, and a bottom step 40. Paired middle step supports 42 suspend the middle step 38 from the top step 36. Paired bottom step supports 44 suspend the bottom step 40 from the middle step 38.

The BOTTOM STEP 40 has a top surface 41, a bottom surface 43, a rear edge 51, a downward extending front portion 47, and downward extending side portions 49 each having a bottom step support bore 50 (not visible in FIG. 1).

Each BOTTOM STEP SUPPORT 44 has a lower segment 52 and an upper segment 53. Each lower segment 52 has a bottom end 54 with an inwardly extending bottom step shoulder bolt 56; and also has an upper end 58 with an outwardly extending hinge pin 60. Each upper segment 53 has a top end 62 (partially obscured by the middle step 3 8) and a bottom end 64 with a hinge bore 66 (shown occupied by the hinge pin 60). The top end 62 has an outwardly extending common shoulder bolt 63 (one of which is shown projecting through the middle step 38 and the middle step support 42).

The MIDDLE STEP 38 has a top surface 68, a bottom surface 70, a downwardly extending front portion 71, a rear edge 72, and side portions 74 each having a middle step support bore 76 (obscured by the middle step 38 on one side and by the middle step support 42 on the other side in FIG. 1).

Each MIDDLE STEP SUPPORT 42 has a bottom end 78 having a bore 80; and also has an upper end 82 (obscured by the top step 36 in FIG. 1) having a support-pin-accommodating bore 84 (not visible in FIG. 1).

The TOP STEP 36 has a top surface 86, a bottom surface 88, a downwardly extending front portion 90, a downwardly extending rear portion 92, and downwardly extending side portions 94. Each side portion 94 has an inward-projecting step assembly support pin 96 (not visible in FIG. 1) and a handrail connector bore 97 (not visible in FIG. 1), both located proximate the front portion 90, and also has a keyhole through bore 98 (not visible in FIG. 1) located proximate the rear portion 92.

Each HAND RAIL ASSEMBLY 34 has a hand rail lower portion 46, a hand rail upper portion 48, a hand rail transverse portion 50, and a hand rail rear portion 55. The hand rail lower portion 46 has bolt-accommodating bore 100 and a rearward-curved bottom end 54 carrying a cap 59. A top step connecting bolt 102 is shown occupying the bolt-accommodating bore 100. The hand rail upper portion 48 has a lock pin-accommodating bore 104, shown occupied by a front lock pin 106. The hand rail rear portion 55 has a lock pin-accommodating bore 108, shown occupied by a flanged rear lock pin 110. A cap 112 is disposed on the hand rail rear portion 55.

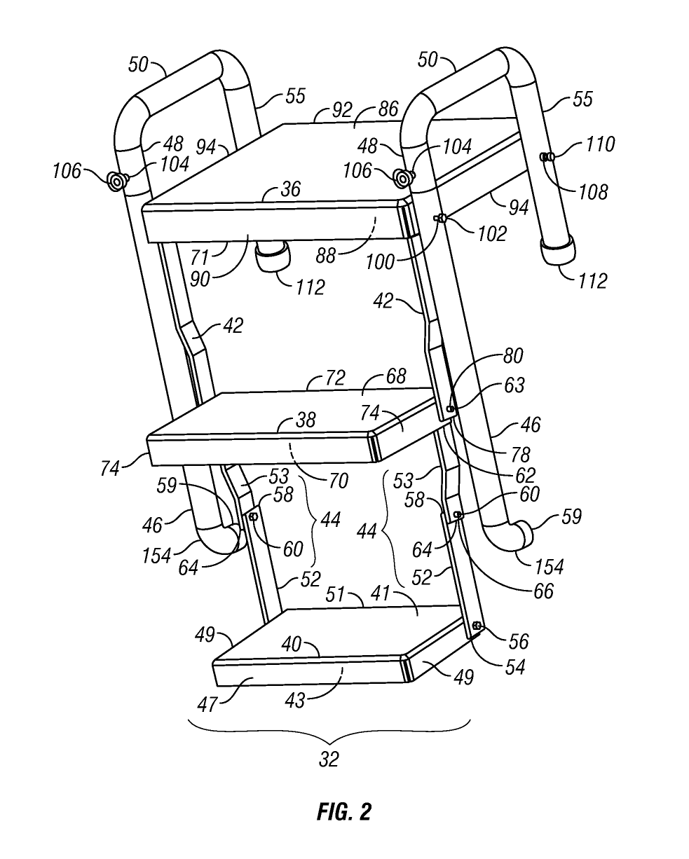

FIG. 2, a perspective view of the preferred embodiment of the tractor tire 28 mountable folding step ladder 30 from a different frontal angle, shows the step assembly 32 with top step 36, middle step 38, bottom step 40; the middle step supports 42 suspending the middle step 38 from the top step 36; and the bottom step supports 44 suspending the bottom step 40 from the middle step 38.

In FIG. 2, the bottom step 40 is again shown with top surface 41, bottom surface 43, rear edge 51, downward extending front portion 47, and downward extending side portions 49 each having bottom step support bore 67 (not visible in FIG. 2).

In FIG. 2, the bottom step supports 44 are again shown with lower segments 52 and upper segments 53. Each lower segment 52 has a bottom end 54 with an inwardly extending bottom step shoulder bolt 56; and also has an upper end 58 with an outwardly extending hinge pin 60. Each upper segment 53 has a top end 62 (partially obscured by the middle step 38) and a bottom end 64 with a hinge bore 66 (shown occupied by the hinge pin 60). The top end 62 has an outwardly extending common shoulder bolt 63 (one of which is shown projecting through the middle step 38 and the middle step support 42).

In FIG. 2, the middle step 38 is again shown with top surface 68, bottom surface 70, rear edge 72, and side portions 74 each having a middle step support bore 76 (obscured by the middle step 38 on one side and by the middle step support 42 on the other side in FIG. 2).

In FIG. 2, the middle step supports 42 are again shown with bottom ends 78 each having a bore 80; and also having upper ends 82 (obscured by the top step 36) each having a bolt-accommodating bore 84 (not visible in FIG. 2).

In FIG. 2, the top step 36 is again shown with top surface 86, bottom surface 88, downwardly extending front portion 90, downwardly extending rear portion 92, and downwardly extending side portions 94. Each side portion 94 has an inward-projecting step assembly support pin 96 (not visible in FIG. 2; see FIG. 7) and a handrail connector bore 97 (not visible in FIG. 2), both located proximate the front portion 90, and also has a keyhole through bore 98 (not visible in FIG. 2) located proximate the rear portion 92.

In FIG. 2, the hand rail assemblies 34 are again shown with hand rail lower portions 46, hand rail upper portions 48, hand rail transverse portions 50, and hand rail rear portions 55. The hand rail lower portion 46 has a bolt-accommodating bore 100 and a rearward-curved bottom end 54 carrying a cap 59. A top step connecting bolt 102 is shown occupying the bolt-accommodating bore 100. The hand rail upper portion 48 has a lock pin-accommodating bore 104, shown occupied by a front lock pin 106. The hand rail rear portion 55 has a lock pin-accommodating bore 108, shown occupied by a flanged rear lock pin 110. A cap 112 is disposed on the hand rail rear portion 55.

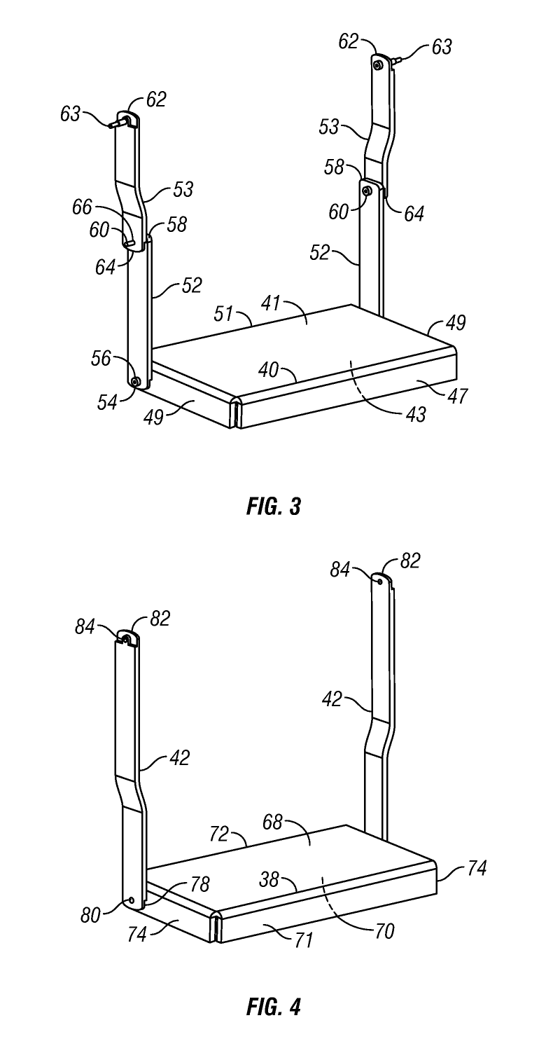

FIG. 3, a partial perspective view of the preferred embodiment of the tractor tire 28 mountable folding step ladder 30, shows the bottom step 40 with top surface 41, bottom surface 43, rear edge 51, downward extending front portion 47, and downward extending side portions 49 each having bottom step support bore 67 (not visible in FIG. 3).

FIG. 3 also shows the lower segments 52 and upper segments 53. Each lower segment 52 has a bottom end 54 with an inwardly extending bottom step shoulder bolt 56 (most of which is obscured in FIGS. 1-3); and also has an upper end 58 with an outwardly extending hinge pin 60 (most of which is obscured on the far side, more of which is visible on the near side). Each upper segment 53 has a top end 62 and a bottom end 64 with a hinge bore 66 (shown occupied by the hinge pin 60). The top end 62 has an outwardly extending common shoulder bolt 63.

FIG. 4, a partial perspective view of the preferred embodiment of the tractor tire 28 mountable folding step ladder 30, shows the middle step 38 with top surface 68, bottom surface 70, rear edge 72, and side portions 74 each having a middle step support bore 76 (obscured by the middle step 38 on one side and by the middle step support 42 on the other side).

FIG. 4 further shows the middle step 38 supports 42 with bottom ends 78 having bores 80; the middle step 38 also has upper ends 82 with bolt-accommodating bores 84.

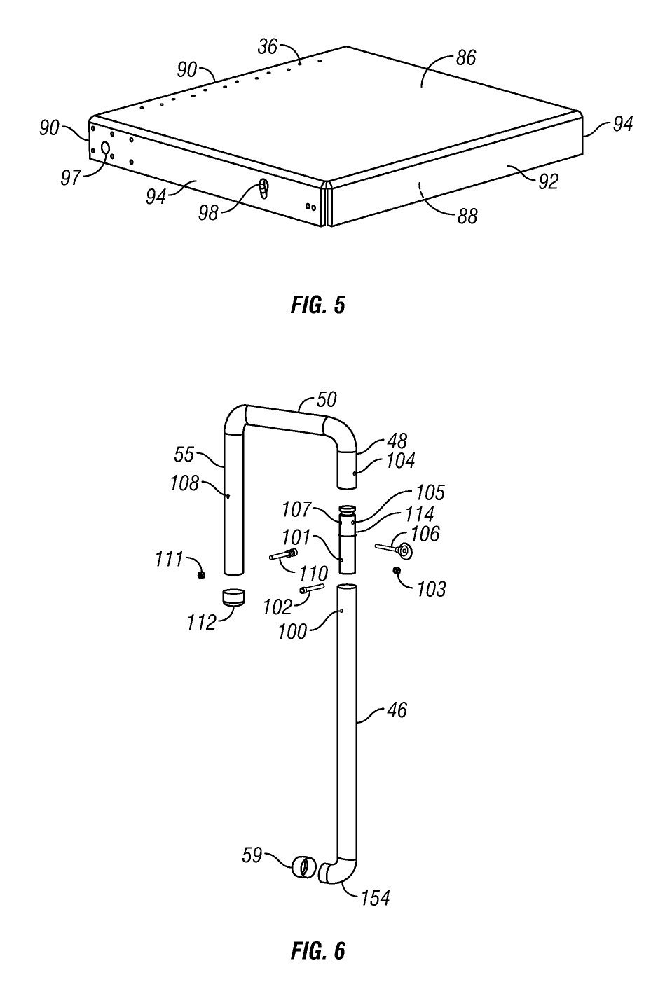

FIG. 5, a partial perspective view of the preferred embodiment of the tractor tire 28 mountable folding step ladder 30, shows the top step 36 with top surface 86, bottom surface 88, downwardly extending front portion 90, downwardly extending rear portion 92, and downwardly extending side portions 94. Each side portion 94 has an inward-projecting step assembly support pin 96 (not visible in FIG. 5) and a handrail connector bore 97, both located proximate the front portion 90, and also has a keyhole through bore 98 (not visible in FIG. 2) located proximate the rear portion 92. This assembly support pin 96 holds the steps in a horizontal configuration.

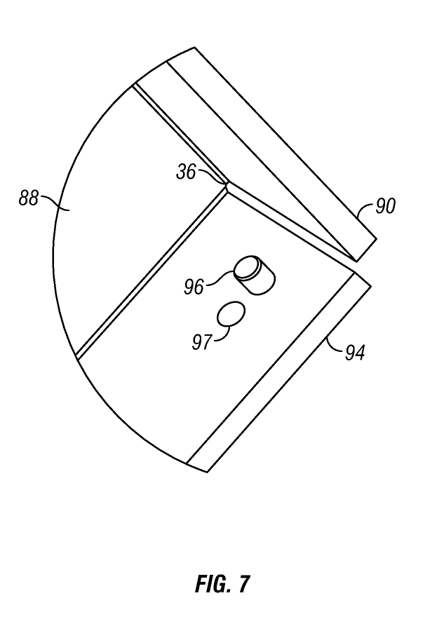

FIG. 6, a partial perspective exploded view of the preferred embodiment of the tractor tire 28 mountable folding step ladder 30, shows the hand rail lower portion 46, hand rail upper portion 48, hand rail transverse portion 50, and hand rail rear portion 55. The hand rail lower portion 46 has a bolt-accommodating bore 100 and a rearward-curved bottom end 54 carrying a cap 59. A top step connecting bolt 102 and its corresponding nut 103 are shown floating proximate the bolt-accommodating bore 100. The hand rail upper portion 48 has a lock pin-accommodating bore 104; the corresponding front lock pin 106 is shown floating in a lateral region of FIG. 6. The hand rail rear portion 55 has a lock pin-accommodating bore 108. The flanged rear lock pin 110 is shown floating in a central region of FIG. 6; the nut 111 is fastened on the end 58 of lock pin 110. A cap 112 is disposed on the hand rail rear portion 55. A hand rail internal segment 114, shown floating between the hand rail lower portion 46 and the hand rail upper portion 48, has a bolt-accommodating bore 101, a lock pin-accommodating bore 105, and a second lock pin-accommodating bore 107 oriented at an angle to the lock-pin-accommodating bore 104.

FIG. 7, a partial perspective view, shows a portion of the top step 36 as viewed from beneath, including the bottom surface 88, the front portion 90, and one side portion 94 with hand rail connector bore 97 and inwardly projecting step assembly support pin 96. The step assembly support pin 96 is provided in the form of a 6.35 mm (0.25 inch) by 9.5 mm (0.375 inch) dowel pin. The primary function of the step assembly support pin 96 is to extend through the bored upper end 82 of the middle step support 42 and thereby to carry loads applied to the middle step 38 and the bottom step 40. Additionally, because the step assembly support pin 96 is located only a short distance from the downwardly extending front portion 90 of the top step, the middle step support 42 (see, e.g., FIG. 2) cannot swing more than a few degrees forward of vertical, due to interference with the front portion 90.

DIMENSIONS of the step ladder 30 and its components are determined chiefly by the dimensions of the tire 28 of the tractor or other vehicle being serviced. While a typical commercial truck tractor tire 28 has a diameter of about 94 cm (37 inches) and a width of between about 20.3 cm (8 inches) and about 35.6 cm (14 inches), these dimensions vary. Ambulances and local delivery trucks have smaller tires, while military trucks and off-road trucks have larger tires. Therefore, an establishment which typically services a given type of vehicle may prefer the step ladder 30 in specifically ordered dimensions. Accordingly, the most preferred length of the top step side portion 94 and the hand rail transverse portion 50 are determined with reference to the size of tires used on a particular customer's fleet.

In an exemplary embodiment of the step ladder 30 in accordance with the present invention, the top step 36 measures about 33 cm (13 inches) front-to-rear and about 40.6 cm (16 inches) wide. The front portion 71 and side portions 94 extend about 4.5 cm (1.75 inches) downward from the top surface 86. The keyhole bore 98 is located in the side portion 94 about 5 cm (2 inches) forward of the rear portion 92. The step assembly support pin 96 extends about 0.6 cm (0.24 inch) from the side portion 94. The middle step 38 measures about 35.6 cm (14 inches) wide and about 17.8 cm (7 inches) front-to-rear and has side portions 74 extending about 4.5 cm (1.75 inches), or slightly less, from the top surface 68. The bottom step 40 measures about 30.5 cm (12 inches) wide and about 17.8 cm (7 inches) front-to-rear and has side portions 49 extending about 4.5 cm (1.75 inches), or slightly less, from the top surface 41. The top step 36, middle step 38 and bottom step 40 have a thickness of about 0.64 cm (0.25 inch).

The lower segment 52 and upper segment 53 of the bottom step support 44 are about 17.8 cm (7 inches) long, about 3.2 cm (1.25 inches) wide and about 0.64 cm (0.25 inches) thick. The middle step support 42 is about 28 cm (11 inches) long, about 3.2 cm (125 inches) wide and about 0.64 cm (0.25) inches thick.

The hand rail assembly 34 is formed of tubes having outside diameter about 3.2 cm (1.25 inches), except that the hand rail internal segment 114 has a slightly smaller diameter suitable for fitting within the hand rail upper portion 46 and the hand rail lower portion 48. The hand rail lower portion 46 is about 51 cm (20 inches) in overall length. The hand rail upper portion 48 extends about 10 cm (4 inches) beyond the hand rail lower portion 46 and curves to join the hand rail transverse portion 50, which extends about 25.4 cm (10 inches) rearward, curving downward to join the hand rail rear portion 55, which extends about 28 cm (11 inches) downward. The height of the transverse portion of the hand rail is preferably about 7.5 cm (3 inches) above the top step.

MATERIALS suitable for the step ladder 30 have high tensile strength and are stiff, hard, not excessively heavy, and relatively impervious to corrosion and abrasion. A preferred embodiment of the step ladder 30 in accordance with the present invention has a top step 36, middle step 38 and lower step formed of aluminum, preferably 5052 aluminum plate; a bottom step support 44 and middle step support 42 formed of aluminum, and a hand rail assembly 34 formed of aluminum tube. Alternative materials include, but are not limited to, other alloys such as a stainless steel alloy or a non-sparking alloy, polymers such as aramid, and composites based on fibers such as carbon fiber or glass fiber and resins such as epoxy. Coatings such as KEVLAR® material also may be employed.

Caps 59 and 112 are preferably formed of rubber or any suitable substitute.

Hardware such as the front lock pin 106, top step connecting bolt 102, flanged rear lock pin 110 and the like are preferably formed of aluminum or another compatible material having comparable strength and hardness. The front lock pin 106 is, for example, a CARR LANE® brand lock pin 1O formed largely of steel alloy and having a ring head (which may be tied to a tether) and a shank equipped with laterally protruding spring-biased ball bearings to hold the shank in place.

In a preferred embodiment of the step ladder 30 in accordance with the present invention, the top surface 86, top surface 68, and top surface 41 are knurled, roughened, hammered, milled, or coated with an abrasive layer or patch to provide improved traction for the operator's shoe bottom and the bottom surface 88 of the top step 36 is given similar treatment for improved traction upon the tire 28 tread.

In accordance with the present invention, a description of certain interrelations among parts of the step assembly 32 facilitates understanding the operation of this exemplary embodiment of the tractor tire 28 mountable foldable step ladder 30. With reference to FIG. 3 and now also to FIG. 12, a bottom sectional view of the bottom step 40, assembly of the step ladder 30 in accordance with the present invention is accomplished with nuts, washers, cotter pins and the like to hold hardware such as bolts in place. The bottom step 40 is permanently hinged to the bottom end 54 of the lower segment 52 of the bottom step support 44 by a standard 0.25 inch by 0.5 inch shoulder bolt 56, shown penetrating the bottom end 54 of the lower segment 52. The bottom step 40 is openable to a limited horizontal, deployed orientation relative to the lower segment 52, because it is back-stopped against a 6.35 mm (0.25 inch) by 9.5 mm (0.375 inch) dowel pin 116.

With particular reference to FIG. 12, the bottom step 40 is shown in bottom sectional view having front portion 47, rear edge 51, and side portions 49. Each side portion 49 has a bottom step support bore 67 and an outward-projecting dowel pin 116. For linkage to the bottom step, the bottom end 54 has a tongue 120 which is penetrated by the bottom step shoulder bolt 56. Cooperating with the dowel pin 116, the bottom end 54 has a stop ridge 122, which because of its location contacts the dowel pin 116 as soon as the bottom step 40 has opened to the deployed orientation relative to the bottom segment 52.

With continued reference to FIG. 3, the upper end 58 of the lower segment 52 is permanently hinged to the bottom end 64 of the upper segment 53 of the bottom step support 44 by hinge pin 60, which also may be provided in the form of a bolt or the like.

The middle step 38, the bottom end 78 of the middle step support 42, and the top end 62 of the upper segment 53 of the bottom step support 44 are held together by common shoulder bolt 63.

With reference to FIG. 3, the downward extending front portion 47 and downward extending side portions 49 stiffen the bottom step 40. The downward extending side portions 49 also provide structure to form the bottom step support bores 67, which receive the respective inwardly extending bottom step shoulder bolts 56 of the bottom ends 54 of the lower segments 52 of the bottom step 40 supports 44. The bottom step 40 is rotatable, relative to the lower segments 52, from a deployed position substantially perpendicular to the lower segments 52, to a second position substantially aligned with and nested between the lower segments 52. This range of rotation is limited because standard 0.25 by 0.5 bottom step shoulder bolt 56 and 0.25 by 0.375 dowel pin 116 are located so that the dowel pin 116 backstops against the stop ridge 122 of the bottom end 54 to prevent the bottom step 40 from drooping when in the deployed orientation relative to the bottom segment 52. This limited range of rotation prevents the bottom step 40 from opening beyond a substantially horizontal orientation, reducing the likelihood that a person climbing the bottom step 40 would slip off.

With continued reference to FIG. 3, the hinge pin 60 projects outwardly through the hinge bore 66 in the bottom end 64 of upper segment 53 and links the lower segment 52 to the upper segment 53. The lower segment 52 is rotatable about the hinge pin 60, relative to the upper segment 53, from a deployed position extending substantially downward from and collinear with the upper segment 53, through a range of about 180 degrees, to a folded position substantially adjacent and parallel to the upper segment 53.

With reference to FIG. 3 and FIG. 4, the common shoulder bolt 63 extends outwardly from the top end 62 of the upper segment 53 of the bottom step support 44 and projects through the middle step 38 and through the bore 80 in the bottom end 78 of the middle step support 42, linking the lower step support 44, the middle step 38 and the middle step support 42. The upper segment 53 of the bottom step support 44 is rotatable about the common shoulder bolt 63, relative to the middle step support 42, over a range of about 180 degrees, from a deployed position projecting substantially downward from and collinear with the middle step support 42 to a folded position substantially adjacent and parallel to the middle step support 42. As in the case of the bottom step 40 (FIG. 3), this range of rotation is limited by the location of the middle step support bore 76 and (which accommodates a standard 0.25 by 0.5 shoulder bolt 56 in similar manner as for bottom step 40 in FIG. 3) close to a 0.25 inch by 0.375 inch dowel pin 116 (also in similar manner as for bottom step 40 in FIG. 3) to back-stop the middle step 38 in the deployed orientation relative to the middle step support 42.

With reference to FIGS. 2, 4 and 7, the upper end 82 of the middle step support 42 has a support-pin-accommodating bore 84. The side portion 94 of the top step 36 proximate the front portion 90 thereof has an inwardly projecting step assembly support pin 96 which extends through the support-pin-accommodating bore 84, linking the middle step support 42 to the top step 36. The middle step support 42 is rotatable about the step assembly support pin 96, relative to the top step 36, from a deployed position projecting substantially downward from and perpendicular to the top step 36, through a range of about 90 degrees, to a folded position substantially adjacent and parallel to the bottom surface 88 of the top step 36. This range of rotation is limited by the location of the step assembly support pin 96 close to the downwardly extending front portion 90, which tends to block the middle step support 42 from swinging forward past an orientation substantially perpendicular to the top step 36. The rearward swing of the middle step support tends to be limited by the presence of the underlying tractor wheel assembly and the sidewall of the tractor tire 28 (FIG. 1) when the step ladder 30 is in use.

With reference to FIG. 2 and FIG. 5, the top step-connecting bolt 102 extends through the bolt-accommodating bore 100 in the hand rail lower portion 46 and through the handrail connector bore 97, linking the side portion 94 of the top step 36 proximate the front portion 90 thereof to the hand rail lower portion 46. The top step 36 is rotatable, about the top step connecting bolt 102, through an angular range of at least 90 degrees, from a deployed position substantially horizontal, parallel to the hand rail transverse portion 50 and perpendicular to the hand rail lower portion 46 and the hand rail rear portion 55, to a folded position substantially vertical and roughly coplanar with the hand rail lower portion 46. The flanged rear lock pin 110 extends through the lock pin-accommodating bore 108 in the hand rail rear portion 55 and inwardly through the keyhole bore 98 in the side portion 94 of the top step 36, linking the side portion 94 of the top step 36 proximate the rear portion 92 thereof to the hand rail rear portion 55. Carrying the weight of the hand rail assembly 34, the flanged real lock pins 110 settle into and become stably lodged within the keyhole bores 98. Thus, the two rear lock pins 110 and the two top step connecting bolts 102 cooperate to provide four-point stabilization of the top step 36 relative to the hand rail assembly 34 (identified generally in FIG. 1).

With reference to FIG. 2 and FIG. 6, the hand rail internal segment 114 is shown floating between the hand rail lower portion 46 and the hand rail upper portion 48 in FIG. 6. In the assembled hand rail assembly 34, best shown in FIG. 2, the hand rail internal segment 114 is not visible, being contained within the hand rail upper portion 48 and the hand rail lower portion 46. The hand rail internal segment 114 fits snugly and extends downward within the hand rail lower portion 46. The bolt-accommodating bore 101 of the hand rail internal segment 114 is aligned with the bolt-accommodating bore 100 of the hand rail lower portion 46. The top step 36 connecting bolt 102 extends through the bolt-accommodating bore 100 of the hand rail lower portion 46 and the bolt-accommodating bore 101 of the hand rail internal segment 14, fixing the hand rail internal segment 114 relative to the hand rail lower portion 46, in addition to linking the hand rail lower portion 46 to the side portion 94 of the top step 36. The hand rail internal segment 114 fits snugly and extends upward within the hand rail upper portion 48. The lock pin-accommodating bore 105 of the hand rail internal segment 114 is aligned with the lock pin-accommodating bore 104 of the hand rail upper portion 48. The front lock pin 106 extends through the lock pin-accommodating bore 104 of the hand rail upper portion 48 and through the lock pin-accommodating bore 105 of the hand rail internal segment 114, fixing the hand rail internal segment 114 relative to the hand rail upper portion 48 and thus also relative to the hand rail lower portion 46. The front lock pin 106 is preferably tethered to the hand rail assembly 34 to avoid loss after removal.

With reference to FIG. 1, the caps 59 on the rearward-curved bottom ends 54 prevent impingement of the rearward-curved bottom ends 54 upon the wheel rim of the tractor or upon persons or equipment while also reducing slippage. The caps 112 on the hand rail rear portions 55 likewise prevent similar impingement.

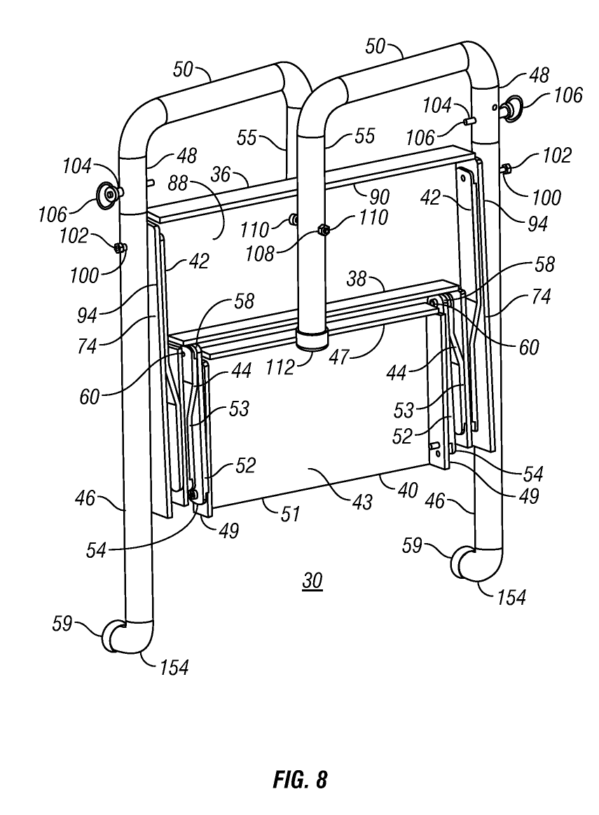

FIG. 8, a perspective view of the preferred embodiment of the tractor tire 28 mountable folding step ladder 30, shows the step ladder 30, generally at 30, in a folded configuration as viewed substantially from the front. Again shown are the top step 36, middle step 38, bottom step 40, the middle step 38 supports 42, and the bottom step 40 supports 44. The bottom step 40 is shown with bottom surface 43, rear edge 51, front portion 47, and side portions 49. The bottom step 40 supports 44 are again shown with lower segments 52 and upper segments 53. Each lower segment 52 has a bottom end 54 with an inwardly extending bottom step shoulder bolt 56; each lower segment 52 also has end 58 with an outwardly extending hinge pin 60. The middle step 38 is shown with front portion 71 and side portions 74. The top step 36 is shown with bottom surface 88, front portion 90, and side portions 94.

FIG. 8 also shows the hand rail lower portions 46 with rearward-curved bottom end 54 carrying a cap 59; hand rail upper portions 48; hand rail transverse portions 50; and hand rail rear portions 55 with caps 112. Top step-connecting bolts 102 are shown occupying the bolt-accommodating bores 100. The hand rail upper portion 48 has a lock pin-accommodating bore 104, shown occupied by a front lock pin 106. The hand rail rear portion 55 has a lock pin-accommodating bore 108, shown occupied by a flanged rear lock pin 110. A cap 112 is disposed on the hand rail rear portion 55.

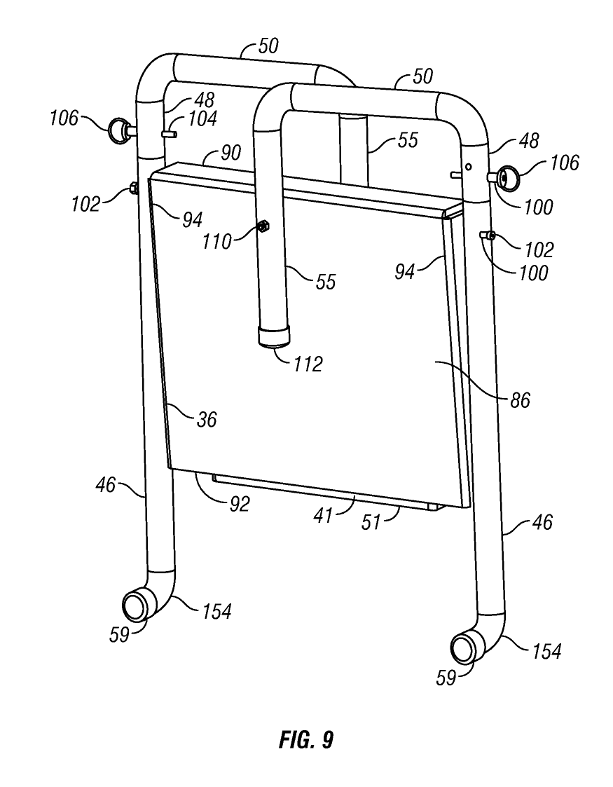

FIG. 9 is a perspective view of the preferred embodiment of the tractor tire 28 mountable folding step ladder 30 in folded configuration, as viewed substantially from the rear. Again shown is the top step 36 having rear portion 92, side portions 94, front portion 90 and top surface 86. Also shown are the rear edge 51 and a small part of the top surface 41 of the bottom step 40. Hand rail lower portions 46 are shown with rearward-curved bottom ends 54 carrying caps 59; also shown are hand rail upper portions 48; hand rail transverse portions 50; and hand rail rear portions 55 with caps 112. Top step connecting bolts 102 are shown occupying the bolt-accommodating bores 100. The hand rail upper portion 48 has a lock pin-accommodating bore 104, shown occupied by a front lock pin 106. The hand rail rear portion 55 has a lock pin-accommodating bore 108, shown occupied by a flanged rear lock pin 110. A cap 112 is disposed on the hand rail rear portion 55.

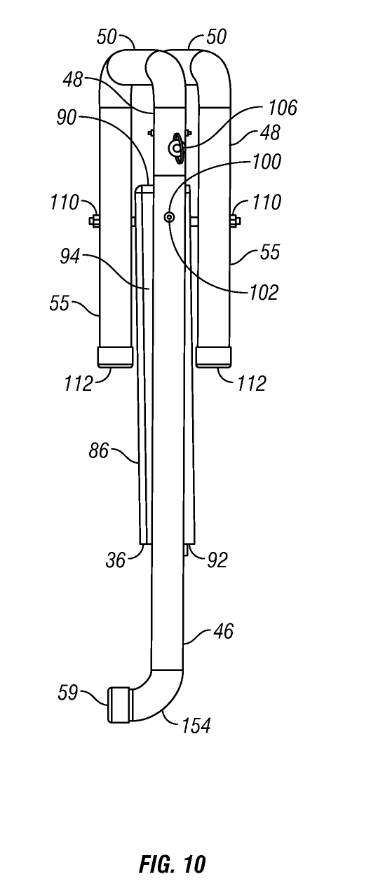

FIG. 10 is a side elevational view of the preferred embodiment of the tractor tire 28 mountable folding step ladder 30 in folded configuration, showing the top step 36 with rear portion 92, side portion 94, front portion 90 and top surface 86. Hand rail lower portions 46 are shown with rearward-curved bottom ends 54 carrying caps 59; also shown are hand rail upper portions 48; hand rail transverse portions 50; and hand rail rear portions 55 with caps 112. Top step 36 connecting bolts 102 are shown occupying the bolt-accommodating bores 100. The hand rail upper portion 48 has a lock pin-accommodating bore 104 (obscured), shown occupied by a front lock pin 106. The hand rail rear portion 55 has a lock pin-accommodating bore 108, shown occupied by a flanged rear lock pin 110. A cap 112 is disposed on the hand rail rear portion 55.

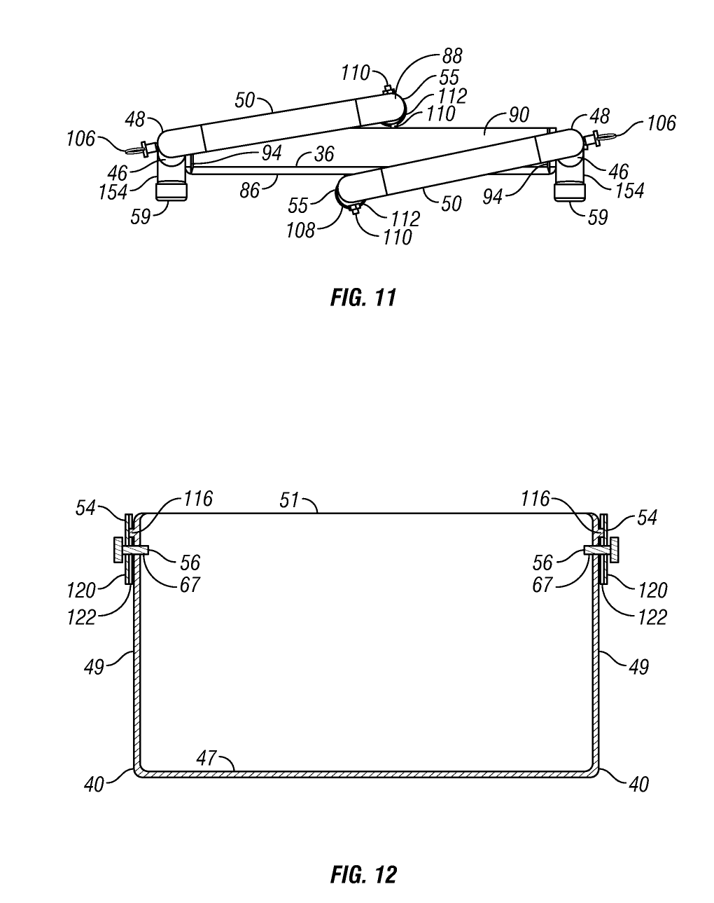

FIG. 11 is a top plan view of the preferred embodiment of the tractor tire 28 mountable folding step ladder 30 in folded configuration, showing the top step 36 with side portions 94, front portion 90 and top surface 86. Hand rail lower portions 46 are shown with rearward-curved bottom ends 54 carrying caps 59; also shown are hand rail upper portions 48; hand rail transverse portions 50; and hand rail rear portions 55 with caps 112. The hand rail upper portion 48 has a lock pin-accommodating bore 104 (obscured), shown occupied by a front lock pin 106. The hand rail rear portion 55 has a lock pin-accommodating bore 108 (obscured), occupied by a flanged rear lock pin 110. A cap 112 is disposed on the hand rail rear portion 55.

With reference to FIGS. 1, 2 and 8, it is seen that the step ladder 30 in accordance with the present invention is configurable in either a deployed configuration (FIG. 2) or a folded configuration (FIG. 8). In the deployed configuration, the bottom surface 88 and the side portions 94 of the top step 36 rest upon the tread portion of a tractor tire 28 as shown in FIG. 1, while the middle step 38 and the bottom step 40 are suspended from the step assembly support pins 96 that project inwardly from the side portions 94 of the top step 36 proximate the front portion 90 thereof. Loads applied to the middle step 38 and the bottom step 40 are thus transferred to the top step 36 proximate the front portion 90 thereof. The hand rail rear portions 55 extend downward behind the tractor tire 28 in a hook-like fashion, engaging the inner side wall of the tractor tire 28, thereby resisting any applied lateral force that might pull the top step 36 off of the tire 28. The rearward-curved bottom ends 54 with caps 56 engage the wheel rim of the tractor (not shown in the drawing figures), resisting rotation of the hand rail assembly 34 and top step 36 due to torque resulting from climbing or grasping loads applied to the step assembly 32 or to the hand rail assembly 34. It will be recalled that in the deployed configuration, the top step 36 is four-point-stabilized relative to the hand rail assembly 34. The downwardly extending side portions 94 of the top step 36 carry most of the downward load of the top step 36 and, being spaced apart along the circumference of the tire 28, stabilize the entire step ladder 30 on the tire 28 and resist clockwise or counterclockwise rotation of the step ladder 30 relative to the tire 28 when uneven forces are applied to the hand rail assembly 34 or to the step assembly 32.

With continued reference to FIGS. 1, 2 and 8, transition from the deployed configuration to the folded configuration begins when a user grasps the hand rail transverse portions 50 and lifts the step ladder 30 away from the tire 28. With the load between the top step 36 and the hand rail rear portion 55 reversed, the flanged rear lock pins 110 are in lifting proximity and alignment with the keyhole bores 98 of the side portions 94 of the top step 36 and are therefore free to be withdrawn from the keyhole bores 98 as soon as the hand rail rear portions 55 can be moved laterally away from the side portions 94 of the top step 36. The user withdraws the front lock pins 106 from the lock pin-accommodating bores 104 of the hand rail upper portions 48, freeing the hand rail upper portions 48 to rotate relative to the hand rail internal segments 114 and relative to the hand rail lower portions 46. The user rotates the hand rail rear portions 55 away from the top step 36, withdrawing the flanged rear lock pins 110 from the keyhole bores 98, with the result that the top step 36 is linked to the hand rail assembly 34 only by the top step connecting bolts 102. The rear portion 92 of the top step 36 falls along an arcuate path toward the hand rail lower portion 46, whereupon the bottom surface 88 of the top step 36 faces forward. To collapse the bottom step 40, the user lifts and rotates the front portion 47 of the bottom step 40 to a location between the upper ends 58 of the lower segments 52 of the bottom step 40 supports 44. The user rotates the bottom ends 64 of the upper segments 53 of the bottom step 40 supports 44 forward and upward until the upper segments 53 abut the bottom surface 70 of the middle step 38. The user lets the middle step 38 supports 42 fall downward and rearward into proximity with the now-forward-facing bottom surface 88 of the top step 36, whereupon the top surface 41 of the bottom step 40 is moved against the bottom surface 70 of the middle step 38 and the top surface 68 of the middle step 38 is moved against the bottom surface 88 of the top step 36, all suspended between and roughly in plane with the hand rail lower portions 46. The user rotates both of the hand rail upper portions 48 clockwise, or both counterclockwise, relative to the respective hand rail lower portions 46 until one hand rail rear portion 55 abuts the front portion 47 of the bottom step 40, the front portion 71 of the middle step 38, and the front portion 90 of the top step 36, while the other hand rail rear portion 55 abuts the top surface 86 of the top step 36. As a result, the entire step assembly 32 is retained between the hand rail rear portions 55. The user reinserts the front lock pins 106 in the lock pin-accommodating bores 104 of the hand rail upper portions 48, fixing the hand rail upper portions 48 relative to the hand rail internal segments 114 and thus relative to the hand rail lower portions 46; however, it is noted that the front lock pins 106 now pass through the second lock pin-accommodating bores 107 (used for storage), which are at an angle relative to the lock pin-accommodating bores 105 (for deployment), in the hand rail internal segment 114. The angle is predetermined to be appropriate to keep the hand rail rear portions 55 securely abutting the folded step assembly 32. Alternatively, the user leaves the front lock pins 106 hanging tethered and relies on snugness of fit of the hand rail internal segment 114 within the hand rail upper portion 48 to hold the hand rail rear portions 55 in abutting relation to the folded step assembly 32. The step ladder 30 is now in the folded configuration. The user conveniently carries the folded step ladder 30 by grasping one of the hand rail transverse portions 50 and secures the folded step ladder 30 in a relatively small space.

As can be seen from the drawing figures and from the description, each embodiment of the tractor tire 28 mountable folding step ladder 30 in accordance with the present invention solves a problem by addressing the need for a portable, safe and stable platform to mount and access the engine compartment to perform required maintenance and repetitive checks in the normal daily operation of a tractor trailer or other type of vehicle.

While the specification describes particular embodiments of the present invention, those of ordinary skill can devise variations of the present invention without departing from the inventive concept. For example, more or fewer steps can be employed, the dimensions can be varied considerably to make a narrower or wider ladder to accommodate different size customers or markets. Additional or fewer pins can bolts may be employed in different combinations.

1. A tire-mountable step ladder for temporary attachment to a tire of a front wheel proximate an engine compartment of a tractor, truck cab, or the like, comprising:
a tire-mountable step assembly; and
a tire-mountable hand rail assembly linked to said step assembly.

2. The step ladder of claim 1, wherein said hand rail assembly comprises a hand rail traversing the tread portion of the tire when the step ladder is mounted on the tire.

3. The step ladder of claim 2, wherein said hand rail is supported at a clearance of at least about 7.5 cm (three inches) above the top step.

4. The step ladder of claim 3, wherein said hand rail is supported at said clearance by said hand rail assembly and said hand rail assembly is supported by said step assembly.

5. The step ladder of claim 4, wherein said step assembly rests on the tread portion of the tire and said hand rail assembly is substantially fixed relative to said step assembly.

6. The step ladder of claim 5, wherein said hand rail assembly stabilizes said step assembly on the tire.

7. The step ladder of claim 6, comprising a plurality of steps, at least one of said steps being suspended from another of said steps.

8. The step ladder of claim 7, wherein, when the step ladder is removed from the tire, said plurality of steps are manipulable into a configuration wherein all of said plurality of steps are moved together in successive top-to-bottom abutting relation.

9. The step ladder of claim 1, wherein:
said step assembly comprises a top step having side portions, a front, a rear and a tread-engaging bottom surface; and
said hand rail assembly comprises lower portions connected to said side portions of said top step proximate said front portion thereof and extending downward therefrom, a transverse portion extending rearward proximate said side portions of said top step, and a rear portion connected to said side portions of said top step proximate said rear portion thereof and extending downward therefrom.
